(19) United States
(12) Patent Application Publication
(10) Pub. No.: US 2012/0063028 A1
(43) Pub. Date: Mar. 15, 2012

(54) MAGNETIC RECORDING APPARATUS

(75) Inventors: Masatoshi SAKURAI, Tokyo (JP); Akihiro Itakura, Akishima-shi (JP); Kazuto Kashiwagi, Ome-shi (JP)

(73) Assignee: Kabushiki Kaisha Toshiba, Tokyo (JP)

(21) Appl. No.: 13/209,192

(22) Filed: Aug. 12, 2011

(30) Foreign Application Priority Data
Sep. 10, 2010 (JP) 2010-203603

(51) Int. Cl. G11B 5/55

(52) U.S. Cl. 360/78.01; G9B/5.182

(57) ABSTRACT

According to one embodiment, there is provided a magnetic recording apparatus including a bit-patterned medium having a data area including magnetic dot rows each of which includes magnetic dots, a magnetic head having a width covering a plurality of magnetic dot rows, and an actuator configured to actuate the magnetic head in a cross-track direction. The magnetic dots included in a n-th magnetic dot row have a higher coercivity than the magnetic dots included in a (n+1)-th magnetic dot row.

### CROSS-REFERENCE TO RELATED APPLICATIONS

This application is based upon and claims the benefit of priority from Japanese Patent Application No. 2010-203603, filed Sep. 10, 2010; the entire contents of which are incorporated herein by reference.

### FIELD

Embodiments described herein relate generally to a magnetic recording apparatus.

### BACKGROUND

In recent years, with increased multifunctionality and operation speeds of information apparatuses such as personal computers and hard disk recorders, the amount of information handled by users has been increasing. Thus, the density with which an information recording apparatus records data to a recording medium has been desired to be increased. Increase in recording density requires miniaturization of a recording cell or mark that is a write unit for recording in a recording medium. However, for conventional recording media, miniaturization of recording cells or marks is confronted with serious challenges.

In recording media for current hard disk apparatuses, a granular thin film of thickness several tens of nanometers is deposited on a disk substrate. When grains in the granular thin film are miniaturized in order to increase the recording density, thermal fluctuation, i.e., a phenomenon in which a decrease in the volume of magnetic grains reduces the ratio of magnetic energy to thermal energy causing recording magnetization to change or disappear under the effect of temperature, occurs to make recording unstable in small polycrystals. Thus, although no problem occurs when the recording cells are large, recording may be unstable or noise increases when the recording cells are small. This is because the smaller recording cell contains a reduced number of crystal grains and contributes to relative increase in the level of the interaction between recording cells.

To avoid this problem, a bit-patterned medium (BPM), which may be simply referred to as a patterned medium, has been proposed as a next-generation magnetic recording medium that replaces the thin film medium; in the bit-patterned medium, a recording material is separated by a non-recording material in advance, and read and write are carried out using a single dot of recording material as a single recording cell.

The bit-patterned medium includes a magnetic dot array with nanometer scale magnetic dots regularly arrayed on a substrate. A digital signal of “0” or “1”, where one dot corresponds to one bit, is recorded in the bit-patterned medium depending on the direction of magnetization in each of the magnetic dots. In the bit-patterned medium, the bits are physically completely isolated from one another. This in principle prevents possible noise resulting from magnetization transition, which is a major factor that hinders increase in the recording density of a continuous film medium.

However, the following problem is posed by the patterned medium in which the recording material is separated by a non-recording material on the surface of the recording medium. That is, a recording element needs to write data to each of the separated recording cells when recording the data in the recording medium at a particular position. Thus, adjusting timing at which the recording element starts recording is important. If the recording is started at the wrong timing, the recording element may perform a write operation on the non-recording material or on the adjacent recording cells. This may result in an increase in the number of write errors.

In the bit-patterned medium, the dots are arrayed in a square lattice pattern in which dot positions are in phase between adjacent dot rows in the track direction or a zigzag pattern in which dot positions are out of phase between adjacent dot rows.

In the lattice pattern, in which the dots are aligned with one another lengthwise and crosswise, read and write are carried out using one dot row as one track. Thus, precise restrictive conditions are required for conditions in the cross track direction such as a head core width, tracking, and the like.

On the other hand, in the zigzag pattern, which includes a large number of dot rows arranged at a given dot pitch, an odd numbered dot row is out of phase with a corresponding even numbered dot row by 180 degrees. When a head with a width covering two adjacent dot rows is utilized to carry out read and write using two dot rows as one data track, for example, the conditions in the cross track direction such as the head core width, tracking, and the like are relieved. However, if recording is carried out on the zigzag pattern using two dot rows as one data track, a write phase margin decreases because the recording has to be preformed at a half pitch of a dot pitch in a dot row.

Thus, to increase the write phase margin, what is called shingled recording may be carried out in which the head records data in one dot row while moving in the cross track direction.

However, even if the arrangement of magnetic dots and recording modes are specially designed for the bit-patterned medium as described above, there is still room for improvement in regard to a fringe effect in recording and a crosstalk effect in readout.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing a magnetic recording apparatus according to an embodiment;

FIG. 2 is a plan view showing an example of a bit-patterned medium used in the magnetic recording apparatus according to an embodiment;

FIG. 3 is a graph showing the relation between the diameter and the coercivity of a circular magnetic dot;

FIG. 4 is a graph showing the relation between the minor diameter and the coercivity of an elliptic magnetic dot;

FIGS. 5A, 5B, 5C and 5D are sectional views showing a method of manufacturing a stamper used for manufacturing a bit-patterned medium;

FIGS. 6A, 6B, 6C, 6D, 6E, 6F, 6G and 6H are sectional views showing a method of manufacturing a bit-patterned medium;

FIG. 7 is a plan view of a bit-patterned medium according to Reference Example;

FIG. 8 is a plan view of a bit-patterned medium according to Example 1;

FIG. 9 is a plan view of a bit-patterned medium according to Example 2;

FIG. 10 is a plan view of a bit-patterned medium according to a modification;

FIG. 11 is a plan view of a bit-patterned medium according to Example 3; and

FIGS. 12A, 12B, 12C and 12D are plan views of a bit-patterned medium according to Example 4.

### DETAILED DESCRIPTION

Various embodiments will be described hereinafter with reference to the accompanying drawings.

In general, according to one embodiment, there is provided a magnetic recording apparatus including a bit-patterned medium having a data area including magnetic dot rows each of which includes magnetic dots, a magnetic head having a width covering a plurality of magnetic dot rows, and an actuator configured to actuate the magnetic head in a cross-track direction. The magnetic dots included in a n-th magnetic dot row have a higher coercivity than the magnetic dots included in a (n+1)-th magnetic dot row.

FIG. 1 is a block diagram for explaining the configuration of a magnetic recording apparatus according to the embodiment.

A disk drive 1 comprises a disk 10 which is a magnetic recording medium, a spindle motor (SPM) 11 for rotating the disk 10, a head 12, an actuator 13, and a head amplifier unit (head IC) 14. The disk 10 is a bit-patterned medium. The bit-patterned medium includes a magnetic dot array in which nanometer-scale magnetic dots are regularly arrayed on a substrate. A digital signal “0” or “1” (one dot corresponds to one bit) is recorded depending on the direction of the magnetization of each magnetic dot.

The head 12 has a structure in which a read element 12R and a recoding element 12W are separately mounted on one slider. The read element 12R reads data recorded in the disk 10. The recoding element 12W writes data into the disk 10. The actuator 13 has a suspension on which the head 12 is mounted, an arm, and a voice coil motor (VCM). The actuator 13 configured to actuate, for tracking control, the head 12 in a radial direction (cross-track direction) on the disk 10.

The head amplifier unit 14 includes a read amplifier for amplifying a readout signal read by the read element 12R of the head 12 and outputting the amplified read signal to a read/write channel 15. The head amplifier unit 14 also includes a write driver for converting write data output from the read/write channel 15 into a write signal (write current) and supplying the write signal to the recoding element 12W of the head 12.

The disk drive 1 comprises the read/write channel 15 mounted on a printed-circuit board, a hard disk controller (HDC) 16, a microprocessor (CPU) 17, a memory 18, and a motor driver 19. The HDC 16, the CPU 17, and the memory 18 are mounted on a one-chip integrated circuit 20.

The read/write channel 15 is a signal processing unit for processing a read/write data signal. The HDC 16 configures an interface between the disk drive 1 and an unshown host system (a personal computer or a digital apparatus), and controls a data transfer and read/write operation. The CPU 17 is a main controller of the disk drive 1, and controls head positioning (servo control) and rearranges read/write data. The memory 18 is a flash EEPROM.

The motor driver 19 has an SPM driver for supplying a drive current to the SPM 11, and a VCM driver for supplying a drive current to the VCM of the actuator 13. The VCM driver supplies a drive current to the VCM of the actuator 13 under the head positioning control (servo control) by the CPU 17, and thereby controls the movement of the head 12 in the radial direction on the disk 10.

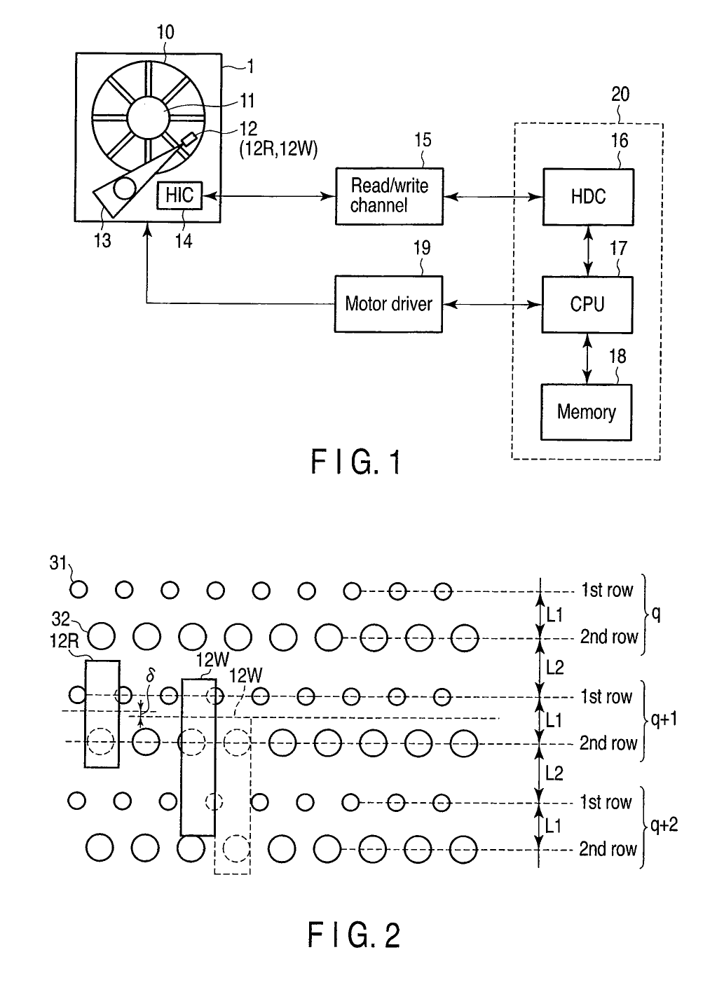

Referring to FIG. 2, an example of a bit-patterned medium used in the magnetic recording apparatus according to the embodiment is described. FIG. 2 is a plan view of the bit-patterned medium.

The planar structure of the bit-patterned medium according to the embodiment is generally described below. Magnetic dots constitute a row along the circumferential direction of the disk to form a magnetic dot row. Rows (from the first row to the t-th row; t is a natural number) of magnetic dots constitute a group to form a sub-area. Groups (from the first group to the z-th group; z is a natural number) of sub-areas form a data area.

Here, the planar structure of the bit-patterned medium is described in more detail in connection with the example wherein recording is performed by a shingled recording mode. A given magnetic dot row in one sub-area is referred to as the n-th row, and an adjacent dot row in which shingled recording is performed after the n-th row is referred to as the (n+1)-th row. Moreover, a given sub-area is referred to as the q-th group, and an adjacent sub-area in which shingled recording is performed after the q-th group is referred to as the (q+1)-th group. When serial numbers are assigned to all of the magnetic dot rows, a row number of a given magnetic dot row is represented by an equation t(q−1)+n (here, q is a natural number ranging from 1 to z, and n is a natural number ranging from 1 to t). In the embodiment, the coercivity of the magnetic dot included in the n-th magnetic dot row is higher than the coercivity of the magnetic dot included in the (n+1)-th magnetic dot row.

In FIG. 2, the first and second (t=2) magnetic dot rows constitute one group to form the sub-areas of the q-th group, the (q+1)-th group, and the q+2-th group. In FIG. 2, the coercivity of a magnetic dot 31 included in the first magnetic dot row is higher than the coercivity of a magnetic dot 32 included in the second magnetic dot row.

In the embodiment, the recoding element 12W of the magnetic head has a width that covers the magnetic dot rows, and records in the n-th magnetic dot row and then records in the (n+1)-th magnetic dot row by the shingled recording mode. That is, the tracking control is performed by the actuator so that the edge of the recoding element 12W in the cross-track direction covers the n-th magnetic dot row to write data. At the same time, the recoding element 12W has a width that covers the magnetic dot rows (e.g., three rows), so that the same data is also written into the (n+1)-th magnetic dot row and the (n+2)-th magnetic dot row. The recoding element 12W is then moved one dot row in the cross-track direction by the actuator, and the tracking control is performed so that the edge of the recoding element 12W in the cross-track direction covers the (n+1)-th magnetic dot row to write data. The recoding element 12W is then moved one dot row in the cross-track direction by the actuator, and the tracking control is performed so that the edge of the recoding element 12W in the cross-track direction covers the (n+2)-th magnetic dot row to write data. In the shingled recording mode, recording is performed at a write frequency adapted to a dot pitch in any magnetic dot row, so that there is no decrease of a write phase margin. Thus, the arrangement precision of the magnetic dots of the bit-patterned medium and the precision of the width of the recoding element 12W can be less strict.

In the embodiment, the read element 12R of the magnetic head also has a width that covers the magnetic dot rows, and sequentially reads out, for example, the magnetic dots included in the n-th and (n+1)-th magnetic dot rows.

As described above, if the coercivity of the magnetic dots included in the n-th magnetic dot row is higher than the coercivity of the magnetic dots included in the (n+1)-th magnetic dot row, a fringe effect on the n-th magnetic dot row can be inhibited when shingled recording is performed in the (n+1)-th magnetic dot row.

The coercivity of magnetic dots can be controlled by setting the magnetic dots included in the n-th magnetic dot row to the same thickness as the magnetic dots included in the (n+1)-th magnetic dot row and changing their sectional shapes in a plane parallel to the surface of the medium. As will be described later, this is because the method that changes the shape of the magnetic dot is easy when the method of manufacturing the bit-patterned medium is considered.

For example, as shown in FIG. 2, the cross-sectional area of the magnetic dot included in the n-th magnetic dot row is set to be smaller than the cross-sectional area of the magnetic dot included in the (n+1)-th magnetic dot row.

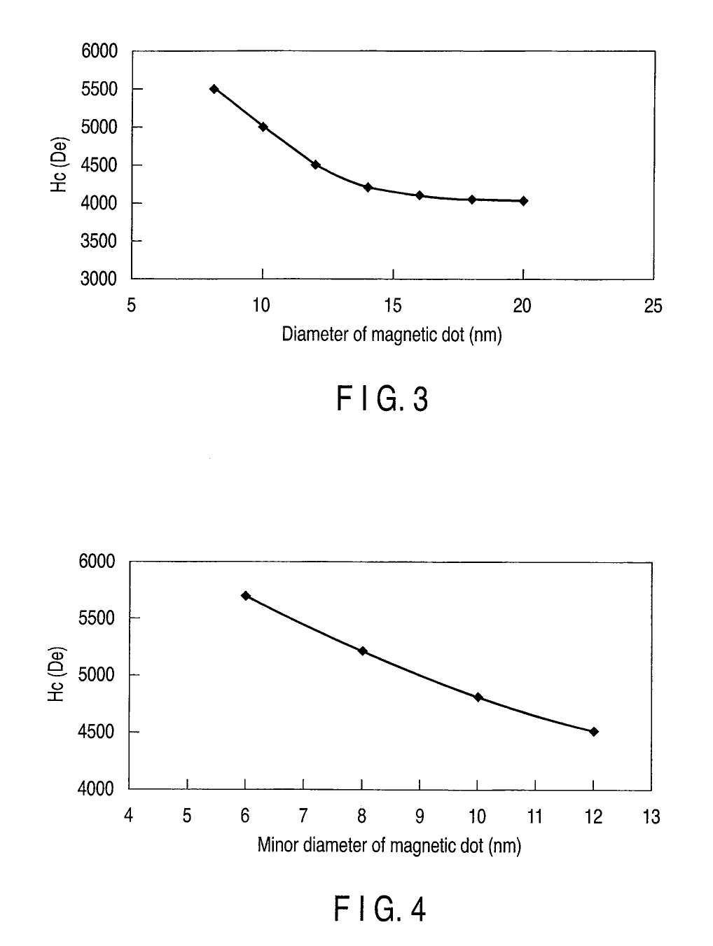

Here, coercivity obtained when a sample in which circular magnetic dot patterns isolated from one another are arrayed is measured by a Kerr effect measuring apparatus is described. In this case, various samples having varied diameters of magnetic dots are measured. FIG. 3 is a graph showing the relation between the diameter and the coercivity of a circular magnetic dot. As shown in FIG. 3, the coercivity of the magnetic dot decreases as the diameter of the magnetic dot increases.

The length of the minimum straight line passing through the center of gravity of the sectional shape of the magnetic dot included in the n-th magnetic dot row may be smaller than that of the magnetic dot included in the (n+1)-th magnetic dot row. The length of the minimum straight line passing through the center of gravity of the sectional shape of the magnetic dot refers to a minor diameter when, for example, the magnetic dot has an elliptic sectional shape including a minor axis in a track direction and a major axis in the cross-track direction.

Here, coercivity obtained when a sample in which elliptic magnetic dot patterns isolated from one another are arrayed is measured by the Kerr effect measuring apparatus is described. In this case, various samples are measured in which the volume of the elliptic magnetic dot is adjusted to the volume of a circular dot having a diameter of 12 nm and the minor diameter and major diameter of the ellipse are changed. FIG. 4 is a graph showing the relation between the minor diameter and coercivity of an elliptic magnetic dot. As shown in FIG. 4, the coercivity of the elliptic magnetic dot decreases as the minor diameter of the magnetic dot increases.

Now, the method of manufacturing the bit-patterned medium is roughly described. The bit-patterned medium according to the embodiment is manufactured by an imprinting method that uses a stamper.

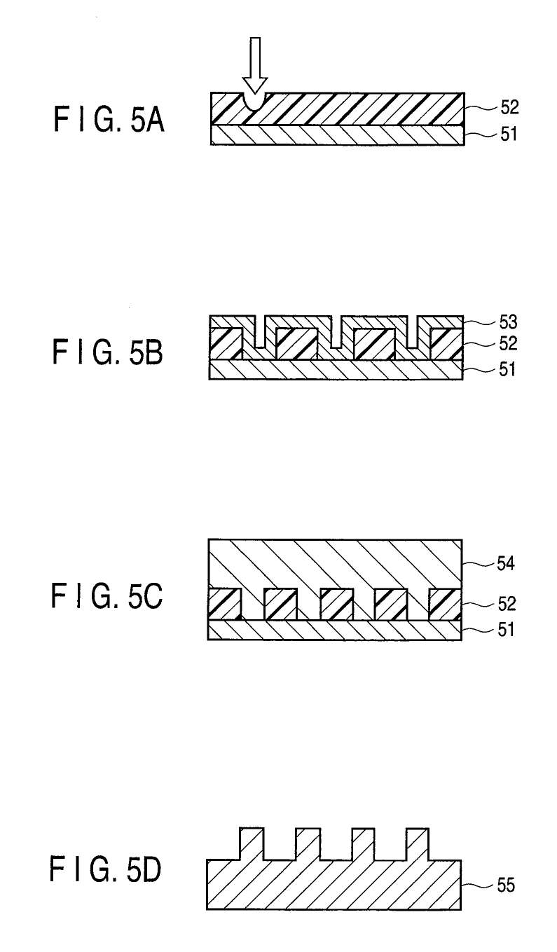

A method of manufacturing a nickel stamper is described with reference to FIGS. 5A to 5D.

As shown in FIG. 5A, an Si wafer is used as a substrate 51, and the substrate 51 is spin-coated with a resist solution, and then the resist solution is baked, thereby forming a resist layer 52. Further, a desired pattern is directly drawn in the resist layer 52 on the substrate 51 by use of an electron beam writing apparatus. In this case, the pattern is drawn in accordance with the shape of the magnetic dot of the bit-patterned medium. The resist is immersed and developed in a developing solution, thus producing a resist master.

As shown in FIG. 5B, a nickel conducting film 53 is formed on the surface of the resist master by sputtering. As shown in FIG. 5C, the resist master on which the conducting film 53 is formed is immersed in a nickel sulfamate plating bath, and nickel is electroformed to form an electroformed layer 54. As shown in FIG. 5D, the electroformed layer 54 and the conducting film 53 are detached from the resist master, thereby obtaining a nickel stamper 55 in which a convexo-concave pattern corresponding to the bit-patterned medium is formed.

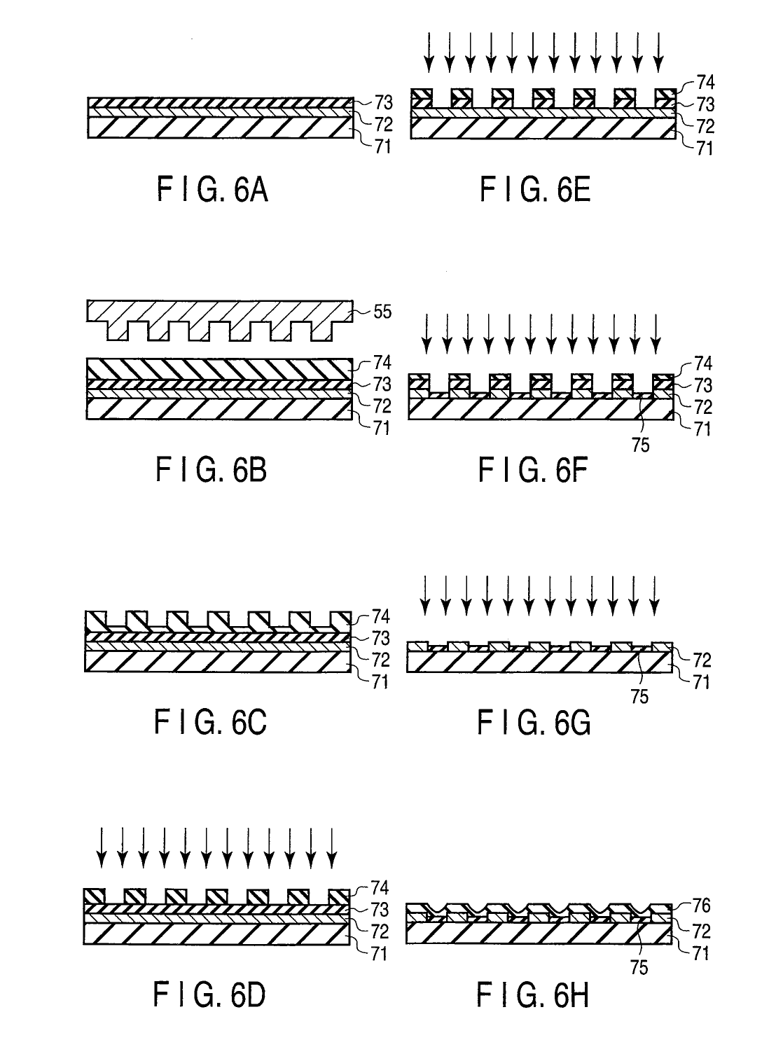

The bit-patterned medium manufacturing method using the nickel stamper is described next with reference to FIGS. 6A to 6H.

As shown in FIG. 6A, the following layers are sequentially formed on a glass substrate 71; a soft magnetic foundation layer (not shown) having a thickness of 120 nm and made of CoZrNb, an alignment control foundation layer (not shown) having a thickness of 20 nm and made of Ru, a magnetic recording layer 72 having a thickness of 10 nm and made of Co₅₀Pt₅₀, and an etching protection layer 73 having a thickness of 15 nm and made of carbon. Here, for simplicity, the soft magnetic foundation layer and the alignment control foundation layer are not shown.

As shown in FIG. 6B, the etching protection layer 73 is spin-coated with a resist 74. The stamper 55 in which the convexo-concave pattern corresponding to the bit-patterned medium is formed is disposed to face the resist 74.

As shown in FIG. 6C, the resist 74 is imprinted by the stamper 55, and convex portions of the resist 74 are formed to correspond to concave portions of the stamper 55. After the imprinting, the stamper 55 is removed. As shown in FIG. 6D, resist residuals remaining at the bottoms of the concave portions of the patterned resist 74 are removed. As shown in FIG. 6E, the pattern of the resist 74 is used as a mask to pattern the etching protection layer 73.

As shown in FIG. 6F, the pattern of the etching protection layer 73 is used as a mask to carry out ion beam etching that uses, for example, an He—N₂ gas. Thus, part of the magnetic recording layer 72 is etched to form concave portions and convex portions therein, and the magnetic recording layer 72 remaining in the concave portions is modified to form a nonmagnetic layer 75.

As shown in FIG. 6G, the pattern of the etching protection layer 73 is removed. At the same time, the resist remaining on the pattern of the etching protection layer 73 is also lifted off. As shown in FIG. 6H, a surface protection film 76 made of carbon is formed by chemical vapor deposition (CVD). Lubricating oil is applied to the surface protection film 76 to obtain the bit-patterned medium according to the embodiment.

As described above, the shape of the magnetic dot of the bit-patterned medium is controlled by an electron beam writing process in FIG. 5A. That is, by changing the shape of the pattern corresponding to a magnetic dot, a magnetic dot in which the pattern shape is reflected can be formed after the fabrication process of the magnetic recording layer 72 in FIG. 6F. However, the patterns function as an etching mask and only determine the presence of the magnetic recording layer 72 that constitutes the magnetic dots. Thus, the composition of the magnetic dot and the thickness of each magnetic dot cannot be controlled by the method shown in FIG. 5 and FIG. 6. Therefore, in order to control the coercivity of the magnetic dot, the method of changing the sectional shape in the plane parallel to the surface of the medium is easy.

In the embodiment, a recording current to record to the magnetic dot included in the n-th magnetic dot row is preferably higher than a recording current to record to the magnetic dot included in the (n+1)-th magnetic dot row.

That is, a recording current running to the magnetic dot included in the (n+1)-th magnetic dot row in which shingled recording is performed later is set to be lower than a recording current running to the magnetic dot included in the n-th magnetic dot row having high coercivity. Therefore, a leakage magnetic field from the recoding element during the subsequent recording can be reduced. Moreover, the coercivity of the magnetic dot in which recording is performed first is high. As a result, a fringe effect on the magnetic dot row in which recording is performed first can be reduced.

As has been described with reference to FIG. 2, when the data area of the bit-patterned medium includes groups of sub-areas each comprising magnetic dot rows, it is preferable that the distance between adjacent magnetic dot rows included in different sub-areas be greater the distance between adjacent magnetic dot rows included in the same sub-area and that the coercivity of the magnetic dot included in the last magnetic dot row of the sub-area of the q-th group be smaller than the coercivity of the magnetic dot included in the first magnetic dot row of the sub-area of the (q+1)-th group.

As already described, if the coercivity of the magnetic dots included in the n-th magnetic dot row is higher than the coercivity of the magnetic dots included in the (n+1)-th magnetic dot row, the fringe effect can be inhibited. Thus, the distance between adjacent magnetic dot rows can be smaller.

On the other hand, gradually changing the coercivity in the order of the shingled recording in the whole data area is not practical because the number of tracks in the data area is great. Thus, practically, a sub-area is formed by magnetic dot rows, and groups of sub-areas are formed, and the coercivity of magnetic dots included in the n-th magnetic dot row in one sub-area is set to be higher than the coercivity of magnetic dots included in the (n+1)-th magnetic dot row, such that the coercivity periodically changes over the sub-areas. In such an arrangement, the coercivity of the magnetic dot included in the last magnetic dot row of the sub-area of the q-th group is smaller than the coercivity of the magnetic dot included in the first magnetic dot row of the sub-area of the (q+1)-th group. In this case, it is preferable that the distance between the last magnetic dot row of the sub-area of the q-th group and the first magnetic dot row of the sub-area of the (q+1)-th group be greater than the distance between the adjacent magnetic dot rows included in the same sub-area in order to inhibit the fringe effect.

In the embodiment, it is preferable that the magnetic dots included in the magnetic dot rows be sequentially read out by one read element. In this case, the distance between the magnetic dot rows read out by one read element can be smaller. Thus, even if the distance between the last magnetic dot row of the sub-area of the q-th group and the first magnetic dot row of the sub-area of the (q+1)-th group is great as described above, recording density can be maintained, and crosstalk during readout can be reduced at the same time.

In the embodiment, it is possible to use a so-called zigzag arrangement wherein among the magnetic dot rows sequentially read out by one read element, positions of the magnetic dots included in the adjacent magnetic dot rows are shifted with respect to the read element.

In this arrangement, in the sequential readout of the magnetic dot rows, the magnetic dots included in each magnetic dot row are sequentially read out, so that recorded data in each magnetic dot row can be separately acquired.

In another embodiment, the magnetic dots included in the magnetic dot rows sequentially read out by one read element may be arranged in phase, and readout signals may be decoded on the basis of the sum of the intensities of the readout signals from the magnetic dots included in the magnetic dot rows.

Thus, if the magnetic dot rows are read and written in phase, the shingled recording in each magnetic dot row is not needed, which allows random recording per readout track that is not enabled by the shingled recording mode. Moreover, the magnetic dot rows are read out in phase, so that the width of the read element can be greater, and manufacturing margin for the read element is improved.

In the embodiment, the magnetic dots included in different magnetic dot rows are varied in shape, and the readout intensity may therefore vary with the magnetic dot rows. In FIG. 2, the intensity of the readout signal from the magnetic dot in the n-th row (first row) having a small cross-sectional area is lower than the intensity of the readout signal from the magnetic dot in the (n+1)-th row (second row) having a large cross-sectional area. In this case, as shown in FIG. 2, it is preferable that the center of the read element 12R be offset a distance S toward the first magnetic dot row from an center position between the first magnetic dot row and the second magnetic dot row when the magnetic dots included in the first and second magnetic dot rows are sequentially read out by one read element 12R. Consequently, the intensity of the readout signal from the first magnetic dot row is increased, and the intensity of the readout signal from the second magnetic dot row is decreased, so that the readout signals from both of the magnetic dot rows are brought to the same intensity, thereby facilitating readout.

### EXAMPLES

Examples are described with reference to the drawings.

In Reference Example and Examples below, a Co₅₀Pt₅₀ alloy having a thickness of 10 nm suitable for perpendicular recording was used as a ferromagnetic film, and the ferromagnetic film was processed to produce bit-patterned media having various structures.

A recoding element and a read element had the following specifications when measured in accordance with read/write in a normal perpendicular magnetic recording medium that used a CoCrPt alloy for a ferromagnetic film. That is, as a result of measurements in recording under a flying height of 2 nm and a recording current (Iw) of 30 mA and in readout under a flying height of 2 nm, the effective width of the recoding element was 100 nm, and the effective width of the read element was 40 nm.

### Reference Example

(Medium structure)

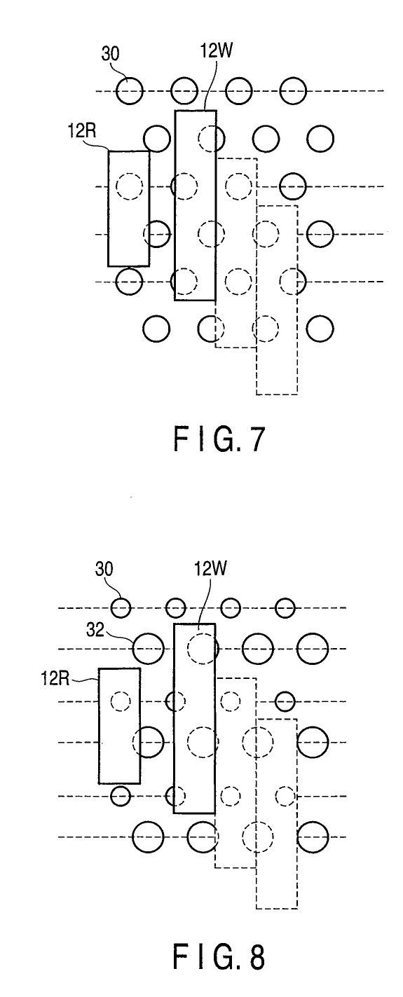

As shown in FIG. 7, a bit-patterned medium having a data area including magnetic dot rows formed by magnetic dots 30 along the circumferential direction of the disk was manufactured.

The shape of the magnetic dot and the arrangement of the magnetic dot rows were as follows. The magnetic dot 30 included in the magnetic dot row had a circular sectional shape of 10 nm in diameter in a plane parallel to the surface of the medium. The dot pitch in one magnetic dot row was 20 nm. The magnetic dots included in adjacent two magnetic dot rows were arranged in a zigzag form so that these magnetic dots were shifted 180 degrees in phase from one another. The distance between the adjacent two magnetic dot rows was 20 nm. The density of the magnetic dots in the data area of this bit-patterned medium was 1.6 T dots/inch².

As shown in FIG. 3, the coercivity of the circular magnetic dot of 10 nm in diameter was 5000 Oe.

In order to avoid the influence of the magnetic dot rows of adjacent groups, an isolation area was formed by leaving two magnetic dot rows and removing the magnetic dot rows on both sides were removed.

(Recording)

The end of the recoding element having the specifications described above was used to perform shingled recording in each magnetic dot row by a flying height of 2 nm and a recording current Iw of 30 mA. In each magnetic dot row, recording was performed by a pattern 101010 . . . in which bits of adjacent magnetic dots were alternately inverted.

(Readout)

Adjacent two magnetic dot rows having the zigzag arrangement were set as one track to perform successive readout. At the same time, the center of the read element was positioned midway between the adjacent two magnetic dot rows having the zigzag arrangement. As the recording was performed in each of the two magnetic dot rows by the pattern 101010 . . . , an expected readout waveform corresponded to a pattern 11001100. . . .

(Recording error rate)

A recording error rate was measured on the basis of the expected readout waveform corresponding to the pattern 11001100. . . . A recording error rate was 3.0×10⁻³ in the isolation area isolating the two magnetic dot rows. As a result of the analysis, it was found out that a recording error mainly occurred in the magnetic dot row in which recording was first performed by shingled recording. This was conceivably attributed to partial magnetization inversion in the n-th magnetic dot row in which recording was first performed resulting from the leakage of a recording magnetic field, that is, a fringe effect when the shingled recording was performed in the (n+1)-th magnetic dot row.

(Crosstalk)

Read operations were respectively performed in the isolation area and in the data area in which the magnetic dot rows were adjacently arranged. Thus, a signal-to-noise ratio (SN ratio) of a readout waveform was measured. The SN ratio in the isolation area was 15 dB, and the SN ratio in the data area was 12 dB. The difference between the isolation area and the data area was in the presence of a magnetic dot row adjacent to a reading track. That is, it was anticipated that an SN loss in the data area was attributed to crosstalk from the adjacent magnetic dot row.

### Example 1

(Medium structure)

As shown in FIG. 8, magnetic dots constituted a row along the circumferential direction of the disk to form a magnetic dot row, and two (t=2) magnetic dot rows constituted a group to form a sub-area, thereby manufacturing a bit-patterned medium having a data area including groups of sub-areas.

The shape of the magnetic dot and the arrangement of the magnetic dot rows were as follows. In each sub-area, a magnetic dot 31 of the first row had a circular shape of 8 nm in diameter, and a magnetic dot 32 of the second row had a circular shape of 12 nm in diameter. The dot pitch in one magnetic dot row was 20 nm. The magnetic dots 31 included in the first magnetic dot row and the magnetic dots included in the second magnetic dot row were arranged in a zigzag form so that these magnetic dots were shifted 180 degrees in phase from one another. In each sub-area, a distance L1 between the first magnetic dot row and the second magnetic dot row was 15 nm. A distance L2 between the second (last) magnetic dot row in the sub-area of the q-th group and the first magnetic dot row in the sub-area of the (q+1)-th group was 25 nm. The density of the magnetic dots in the data area of this bit-patterned medium was 1.6 T dots/inch².

As shown in FIG. 3, the coercivity of the circular magnetic dot of 8 nm in diameter was 5500 Oe, and the coercivity of the circular magnetic dot of 12 nm in diameter was 4500 Oe.

In order to avoid the influence of the magnetic dot rows of adjacent groups, an isolation sub-area was formed by removing the sub-areas on both sides of the sub-area of the first group including two magnetic dot rows.

(Recording)

The end of the recoding element having the specifications described above was used to perform shingled recording in each magnetic dot row by a flying height of 2 nm. A recording current Iw was 35 mA in recording in the first row, and 25 mA in recording in the second row. In each magnetic dot row, recording was performed by a pattern 101010 . . . in which bits of adjacent magnetic dots were alternately inverted.

(Readout)

Adjacent two magnetic dot rows having the zigzag arrangement were set as one track to perform successive readout. As the recording was performed in each of the two magnetic dot rows by the pattern 101010 . . . , an expected readout waveform corresponded to a pattern 11001100. . . .

(Offset of read element during readout)

When the center of the read element was positioned midway between the first magnetic dot row and the second magnetic dot row that were configured to have the zigzag arrangement and readout was then performed, the readout waveform was distorted. As a result of the analysis, the intensity of the readout signal from the first magnetic dot row was low, and the intensity of the readout signal from the second magnetic dot row was high. This was conceivably attributed to the size difference of the magnetic dots that constitute the first and second magnetic dot rows.

The center of the read element was then offset δ=5 nm toward the first magnetic dot row from the center position between the first magnetic dot row and the second magnetic dot row that were configured to have the zigzag arrangement, and readout was performed. As a result, the readout waveform was undistorted. This was conceivably attributed to the fact that the center of the read element, that is, the center of a sensitivity distribution was closer to the first magnetic dot row so that as compared with the case without offset, the intensity of the readout signal from the first magnetic dot row was increased and the intensity of the readout signal from the second magnetic dot row was decreased.

Thus, in the following case, the center of the read element was offset δ=5 nm toward the first magnetic dot row from the center position between the first magnetic dot row and the second magnetic dot row that were configured to have the zigzag arrangement, and readout was performed, so that the result of the readout was examined.

(Recording error rate)

A recording error rate was measured on the basis of the expected readout waveform corresponding to the pattern 11001100. . . .

A recording error rate showed 2.0×10⁻⁵ in an isolation sub-area isolating the two magnetic dot rows. It was found out that the recording error rate was lower than that in Reference Example because the fringe effect on the first row was eliminated during the recording in the second row. This was conceivably attributed to the face that there is less fringe effect because the coercivity of the magnetic dot included in the first magnetic dot row was higher than the coercivity of the magnetic dot included in the second magnetic dot row, and to the face that the fringe effect was inhibited because the recording current Iw for recording in the second magnetic dot row was lower than the recording current Iw for recording in the first magnetic dot row.

(Crosstalk)

Read operations were respectively performed in the isolation sub-area and in the data area in which the sub-areas were adjacently arranged. Thus, a signal-to-noise ratio (SN ratio) of a readout waveform was measured. The SN ratio in the isolation sub-area was 15 dB, which was equal to that in Reference Example. The SN ratio in the data area was 14 dB, and crosstalk was improved as compared with Reference Example. This was conceivably attributed to the face that the distance between the adjacent two magnetic dot rows included in different sub-areas, for example, the distance between the second magnetic dot row of the q-th group and the first magnetic dot row of the (q+1)-th group was greater than the distance between the first magnetic dot row and the second magnetic dot row included in the same sub-area.

Applying the shingled recording mode to the bit-patterned medium having the zigzag arrangement as in this example enables higher recording density, a less strict manufacturing margin for the read/write element, and less strict precision of synchronous recording. In addition, the coercivity of the magnetic dot included in the first magnetic dot row is higher than the coercivity of the magnetic dot included in the second magnetic dot row, such that the fringe effect and the crosstalk are reduced. Moreover, setting the recording current Iw for recording in the second magnetic dot row to be lower than the recording current Iw for recording in the first magnetic dot row is advantageous to the reduction of the recording error rate.

### Example 2

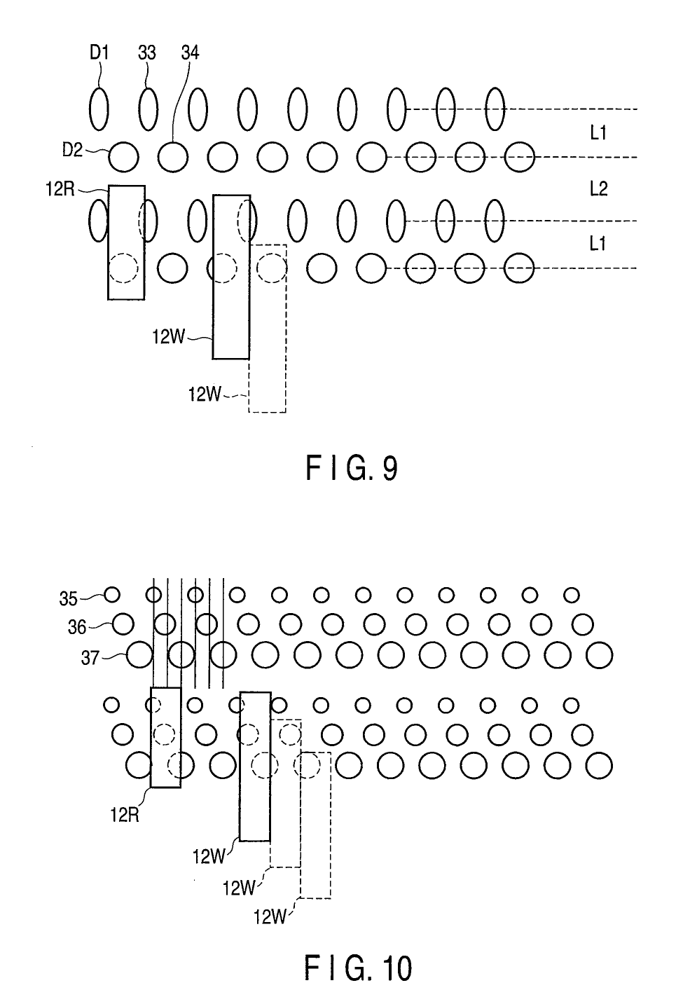

As shown in FIG. 9, a magnetic dot 33 included in the first magnetic dot row had an elliptic shape in which a minor diameter D1 in the track direction was 8 nm and a major axis in the cross-track direction was 18 nm. As shown in FIG. 4, the coercivity of this magnetic dot 33 was 5200 Oe. Moreover, a magnetic dot 34 included in the second magnetic dot row had a circular shape of 12 nm in diameter. As shown in FIG. 3, the coercivity of this magnetic dot 34 was 4500 Oe.

The recording current Iw for recording was 33 mA in recording in the first row, and 25 mA in recording in the second row. The center of the read element was offset δ=3 nm toward the first magnetic dot row from the center position between the first magnetic dot row and the second magnetic dot row that were configured to have the zigzag arrangement, and readout was performed. In other respects, a read/write test similar to that in Example 1 was conducted.

A recording error rate was 2.0×10⁻⁵. Crosstalk was 15 dB in the isolation sub-area, and was 14 dB in the data area. Thus, characteristics similar to those in Example 1 were shown.

### Modification

In FIG. 10, magnetic dots constitute a row along the circumferential direction of the disk to form a magnetic dot row, and three (t=2) magnetic dot rows constitute a group to form a sub-area, thereby providing a bit-patterned medium having a data area including groups of sub-areas.

In this case, in each sub-area, the diameter increases in the order of a magnetic dot 35 in the first row, a magnetic dot 36 in the second row, and a magnetic dot 37 in the third row, while the coercivity decreases in this order.

### Example 3

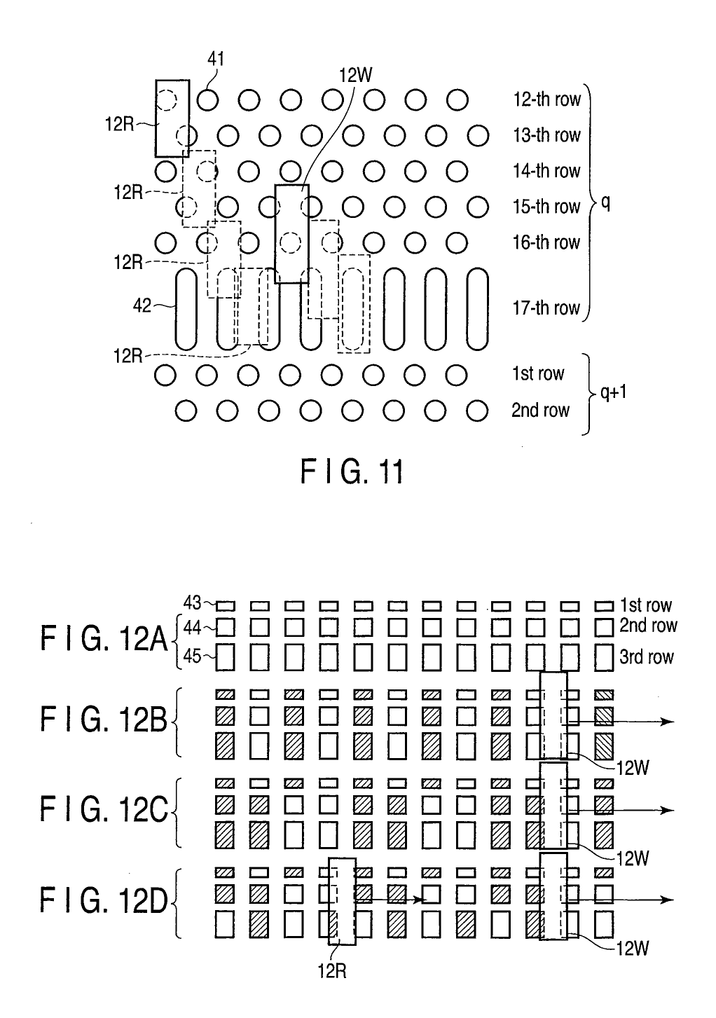

As shown in FIG. 11, 17 magnetic track rows constituted one group to form a sub-area, thereby manufacturing a bit-patterned medium having a data area including groups of sub-areas.

In this example, the 1st to 16-th magnetic dot rows were arranged as in Reference Example, and the width of a magnetic dot 42 included in the 17-th magnetic dot row in the cross-track direction was 100 nm, and the width of a nonmagnetic portion between the magnetic track rows was 10 nm. The coercivity of a magnetic dot 41 was higher than the coercivity of the magnetic dot 42.

The read/write elements having the specifications described above were used to perform shingled recording. Regarding the moving distance of the recoding element in the cross-track direction, the moving distance from the 15-th magnetic dot row to the 16-th magnetic dot row was equal to the moving distance from the 16-th magnetic dot row to the 17-th magnetic dot row. For readout, the read element was located in the center of the 17-th magnetic dot row, and readout was performed.

When the 1st to 16-th magnetic dot rows were read out every two rows, the recording error rate was 3.0×10⁻³, which was equal to that in Reference Example. On the contrary, the recording error rate of the 17-th magnetic dot row was 2.0×10⁻⁷.

According to the magnetic recording apparatus in this example, information that was not much influenced by the recording error rate such as video information could be recorded in the 1st to 16-th magnetic dot rows, and other information that was greatly influenced by the recording error rate could be recorded in the 17-th magnetic dot row.

### Example 4

As shown in FIG. 12A, three magnetic track rows constituted one group to form a sub-area, thereby manufacturing a bit-patterned medium having a data area including groups of sub-areas. Magnetic dots 43, 44, and 45 included in the first to third magnetic dot rows are in phase with one another.

Regarding the shapes of the magnetic dots 43, 44, and 45 included in the first to third magnetic dot rows, the width in the cross-track direction was 5 nm in the first row, 10 nm in the second row, and 20 nm in the third row. The width in the track direction was 10 nm in all of the first to third rows. The coercivities of the magnetic dots 43, 44, and 45 included in the first to third magnetic dot rows were 6000 Oe in the first row, 5000 Oe in the second row, and 4030 Oe in the third row, respectively. The dot pitch in one magnetic dot row was 20 nm. Regarding the width of the nonmagnetic portion between the magnetic track rows, the distance between the first row and the second row was 5 nm, and the distance between the second row and the third row was 10 nm.

Read/write operations were performed in this medium by a magnetic head having the following specification: the effective width of the recoding element was 50 nm, and the effective width of the read element was 50 nm.

In the recording and the readout, the magnetic head was located in the center of the second magnetic dot row, and the read and write were simultaneously performed in the first to third magnetic dot rows.

Recording was performed three times at the same head position. The recording current Iw was 45 mA for the first time, 30 mA for the second time, and 20 mA for the third time.

By analyzing conditions in which the magnetization was inverted by the third recording, conditions shown in FIGS. 12B to 12D were recognized. That is, recording was accomplished in the first to third rows for the first time as shown in FIGS. 12B, recording was accomplished in the second and third rows for the second time as shown in FIGS. 12C, and recording was accomplished in the third row for the third time as shown in FIGS. 12D. This showed that recording was not accomplished in the magnetic dot row having great coercivity when the recording current Iw was low.

In readout, the first to third magnetic dot rows are simultaneously read. If the intensity of the readout signal in the first row is ±1 depending on the size of the magnetic dot included in each magnetic dot row, the intensity of the readout signal is ±2 times in the second row, and the intensity of the readout signal is ±4 times in the third row. The sum of these intensities is obtained as the readout signal intensity for one track. This readout signal intensity can be converted into a recording condition in each magnetic dot.

Consequently, according to this example, read/write can be performed by use of the read element having a greater width than that in Example 1, and the manufacturing margin for the read element can be improved. Moreover, according to this example, read/write can be performed by use of a normal track-by-track recording mode instead of the shingled recording.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording apparatus comprising:
a bit-patterned medium having a data area comprising magnetic dot rows each of which includes magnetic dots;
a magnetic head having a width covering a plurality of magnetic dot rows; and
an actuator configured to actuate the magnetic head in a cross-track direction,
wherein the magnetic dots included in a n-th magnetic dot row have a higher coercivity than the magnetic dots included in a (n+1)-th magnetic dot row.

2. The magnetic recording apparatus of claim 1, wherein the magnetic dots included in the n-th magnetic dot row and the magnetic dots included in the (n+1)-th magnetic dot row are equal in thickness, and different in coercivity due to difference in sectional shapes in a plane parallel to a surface of the medium.

3. The magnetic recording apparatus of claim 2, wherein the magnetic dots included in the n-th magnetic dot row are smaller in cross-sectional area than the magnetic dots included in the (n+1)-th magnetic dot row.

4. The magnetic recording apparatus of claim 2, wherein the magnetic dots included in the n-th magnetic dot row are smaller in a length of a minimum straight line passing through a center of gravity of the sectional shape than the magnetic dots included in the (n+1)-th magnetic dot row.

5. The magnetic recording apparatus of claim 1, wherein recording is performed in the (n+1)-th magnetic dot row after recording in the n-th magnetic dot row.

6. The magnetic recording apparatus of claim 5, wherein a recording current to record to the magnetic dots included in the n-th magnetic dot row is higher than a recording current to record to the magnetic dots included in the (n+1)-th magnetic dot row.

7. The magnetic recording apparatus of claim 1, wherein the data area of the bit-patterned medium comprises groups of sub-areas each of which group includes magnetic dot rows, and wherein the magnetic dots included in a last magnetic dot row in the sub-area of a q-th group have a coercivity lower than the magnetic dots included in a first magnetic dot row in the sub-area of a (q+1)-th group, and a distance between the last magnetic dot row in the sub-area of the q-th group and the first magnetic dot row in the sub-area of the (q+1)-th group is greater than a distance between adjacent magnetic dot rows included in the same sub-area.

8. The magnetic recording apparatus of claim 1, wherein the magnetic dots included in a plurality of magnetic dot rows are sequentially read out by one read element.

9. The magnetic recording apparatus of claim 8, wherein, among the plurality of magnetic dot rows sequentially read out by one read element, positions of the magnetic dots included in adjacent magnetic dot rows are shifted with respect to the read element.

10. The magnetic recording apparatus of claim 8, wherein the magnetic dots included in the plurality of magnetic dot rows are sequentially read out by one read element, and readout signals are decoded based on a sum of intensities of the readout signals from the magnetic dots included in the plurality of magnetic dot rows.

11. The magnetic recording apparatus of claim 8, wherein a center of the read element is offset toward the n-th magnetic dot row from a center position between the n-th magnetic dot row and the (n+1)-th magnetic dot row when the magnetic dots included in both the n-th and (n+1)-th magnetic dot rows are sequentially read out by one read element.
